(19) United States
(12) Patent Application Publication
(10) Pub. No.: US 2004/0046921 A1
(43) Pub. Date: Mar. 11, 2004

(54) Liquid crystal device, method of manufacturing liquid crystal device, and electronic equipment

(75) Inventor: Yoichi Momose, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/618,715

(22) Filed: Jul. 15, 2003

(30) Foreign Application Priority Data
Jul. 22, 2002 (JP) 2002-212765
Apr. 18, 2003 (JP) 2003-114360

(51) Int. Cl. G02F 1/1339

(52) U.S. Cl. 349/153

(57) ABSTRACT

The invention provides a liquid crystal device in which the spacing between substrates in a plane of the substrate can be made uniform easily and simply, and which is less prone to producing a vacuum region in the liquid crystal layer at low temperatures by disposing spacers. A liquid crystal device has a pair of substrates, spacers located between the substrates, and a liquid crystal layer held between the substrates. The liquid crystal and spacers are located inside a closed-frame-shaped seal material formed in a plane of the substrate, a density of the spacers inside the seal material ranges from 100 to 300/mm², and the average particle size of spacers is set in the range of 0.96 d to 1.02 d, where a liquid crystal layer thickness in the region in which the spacers are disposed is represented by d.

### BACKGROUND OF THE INVENTION

1. Field of Invention

The present invention relates to a liquid crystal device, a method of manufacturing the liquid crystal device, and a configuration of electronic equipment having the liquid crystal device. More specifically, the invention relates to a liquid crystal device having spacers between paired substrates to keep a liquid crystal layer thickness uniform.

2. Description of Related Art

Related art liquid crystal devices include a liquid crystal device arranged to have a downside substrate and an upside substrate, which are bonded to each other at the respective peripheries through a seal material, and a liquid crystal layer sealed in between the paired substrates. In this case, the related art includes a technique to locate spacers between a pair of substrates in order to make the spacing between the substrates uniform in a plane of the substrate.

This related art liquid crystal device is manufactured according to the following method. Namely, a liquid crystal cell is obtained by stacking and forming an electrode, alignment layer, etc., on a downside substrate and an upside substrate respectively, then printing a not-yet-cured seal material, for example, on the downside substrate in a form in which a liquid crystal injection port is formed in the periphery of one substrate, dispersing spacers on a surface of the substrate or the other substrate, and bonding the downside and the upside substrates to each other through the not-yet-cured seal material. Then, a liquid crystal layer is formed by curing the not-yet-cured seal material of the liquid crystal cell and injecting a liquid crystal into the liquid crystal cell through a liquid crystal injection port previously formed in the seal material, followed by sealing up the injection port with a sealant. Finally, optical elements including a phase-shift plate and a polarizing plate are formed outside the downside and upside substrates, and therefore a liquid crystal device having the above configuration is manufactured.

In the case of the liquid crystal device so arranged that spacers are interposed in the liquid crystal layer as described above, the particle size and uniformity of dispersed density of spacers to be used will exert a large influence on the properties of the liquid crystal device. Japanese Published Unexamined Patent Application JP-A-08-106101 (hereinafter “JP 101”) discloses such an exemplary use of spacers having a particle size smaller than a liquid crystal layer thickness by 0.2-0.6 μm or 4-12% can ensure the movement of the substrates in re-positioning while maintaining the uniformity of the thickness of the liquid crystal layer between the substrates.

### SUMMARY OF THE INVENTION

In the above-described method of manufacturing a liquid crystal device, a liquid crystal is injected after the substrates have been glued together. However, the process of injecting a liquid crystal requires a lot of time and effort. Therefore, a simpler and easier manufacturing method has been desired. In addition, while spacers are disposed between a pair of substrates in order to keep the spacing between the substrates uniform, variations in the spacing between the substrates can develop even though the spacers have been disposed. The reason for this is the surfaces of the substrates are not perfectly flat since TFT elements, etc., are provided thereon.

Further, in JP 101, when the liquid crystal layer has a thickness of 5 μm, the unevenness in liquid crystal layer thickness is ±0.1 μm. In other words, the unevenness in liquid crystal layer thickness reaches ±2%. Therefore, for example, when such a liquid crystal device is applied to an STN type liquid crystal device, a liquid crystal device using an active element, etc., the contrast can be reduced, and thus the display properties can be deteriorated.

In addition, when an amount of spacers to be dispersed in a liquid crystal device is excess, a vacuum region can be produced in the liquid crystal layer in the case the device is stored at a low-temperature. In contrast, when an amount of spacers is too small, variations in the spacing between substrates can develop.

The invention addresses the above and/or other problems, and provides a liquid crystal device, in which the spacing between substrates can be more uniform in a plane of the substrate simply and easily, and which is less prone to producing troubles at low or high temperatures by disposing suitable spacers. Further, the invention provides a method of manufacturing the liquid crystal device. Also, the invention provides a configuration of electronic equipment having the quid crystal device.

To address or solve the above, the liquid crystal device of the invention is a liquid crystal device having a pair of substrates, spacers located between the substrates, and a liquid crystal layer held between the substrates. The liquid crystal layer and spacers are located in a region surrounded by a frame-shaped seal material formed in a plane of the substrate, a density of the spacers in the region ranges from 100 to 300/mm², and an average particle size D of the spacers ranges from 0.96 d to 1.02 d, where a liquid crystal layer thickness in the region in which the spacers are disposed is represented by d.

According to such liquid crystal device, a seal material is formed into the form of a closed frame in a region in a plane of the substrate. On that account, it is possible to drop a liquid crystal onto one of the substrates before gluing the substrates together, and thereafter glue the substrate to the other one when manufacturing the liquid crystal device. In this case, the manufacturing process becomes simple and easy because it is not required to pass the step of injecting a liquid crystal after having glued the substrates together. Further, the liquid crystal device with such seal material uses spacers ranging from 0.96 d to 1.02 d in average particle size D and from 100 to 300/mm² in spacer density inside the seal material. Consequently, the spacing between substrates become more uniform, and for example variations in spacing between substrates can be reduced to ±1% approximately. In addition, a trouble such that a vacuum region (bubble) develops when the device is stored at low temperatures can be also resolved.

In other words, by the present inventor's energetic examination, the following facts were found. Particularly in the case where spacers have a spacer density less than 100/mm² and an average particle size D below 0.96 d, variations in spacing between substrates develops easily. Further, specially in the case where the spacer density exceeds 300/mm² and the average spacer particle size D is larger than 1.02 d, a vacuum region can be easily produced in storage at low temperatures. The vacuum region arising in storage at a low temperature (e.g. −30° C.) is a mass of minute quantities of gas contained in the liquid crystal produced by the accumulation of the gas at low temperatures and such vacuum region cannot disappear after bringing the device back to a room temperature.

The reason why the density of spacers could be set to a comparatively small value ranging from 100 to 300/mm² in the invention as described above is presumed to lie in the configuration of the seal material. In other words, the reason is presumed as follows. In the case of the invention, a seal material shaped into the form of a closed frame but having no opening (liquid crystal injection port) has been applied, which made possible to drop a liquid crystal onto the substrate and glue the substrates with spacers dispersed in place as described above. Further, in this case, the liquid crystal as well as spacers came to receive a pressure produced in gluing substrates together and thus it became possible to make the number of the spacers relatively smaller in comparison to the case of a related art liquid crystal device configured to have an injection port.

The configuration of the invention thus makes it possible to omit the injecting of a liquid crystal and the sealing of the liquid crystal in the manufacturing process, and further to decrease the density of spacers. Therefore, by setting the density and average particle size of spacers as described above, it becomes possible to provide a liquid crystal device which has an uniform spacing between substrates in a plane of the substrate and is less prone to producing a bubble, etc., in the liquid crystal. The liquid crystal layer thickness d in a region where spacers are disposed herein mentioned means a thickness of a portion effective in controlling the spacing between substrates. For example, as for translucent, reflection type liquid crystal devices in which the liquid crystal layer thicknesses are varied between the reflection region and the transmitted region intentionally, the thickness d refers to a liquid crystal layer thickness in a region which enables effective control of the spacing between substrates when the spacers are disposed in place.

If a seal material having an injection port was to be used to carry out the step of injecting a liquid crystal before gluing substrates together as in the past, a problem, such as the leakage of the liquid crystal to the outside when gluing substrates together, would be posed. Accordingly, it becomes virtually impossible to inject a liquid crystal before gluing substrates together in the case where a seal material with an injection port is formed. In contrast, it is impossible to carry out the injecting of a liquid crystal before gluing substrates together in the case where a seal material with no injection port is used according to the invention. Consequently, the configuration of the invention surely enables the liquid crystal injection before gluing substrates and the decrease in spacer density.

Further, the density of spacers is desired to be 150 to 300/mm². In this case, a problem, such as unevenness in the spacing between substrates arising at high temperatures, becomes less prone to occur. In other words, when the liquid crystal device is heated to a high temperature (e.g. 70° C. or higher), the thermal expansion of the liquid crystal becomes much more significant than that of spacers, and thus spacers cannot sufficiently fulfill its originally intended function of keeping the liquid crystal layer thickness uniform in the case where the density of spacers is small. However, in the case the density of spacers had been set to be more than 150/mm² as described above, the above-described problem at a high temperature could be made less prone to occur. It is difficult to refer to the problem at a high temperature as a defect necessarily, because the problem can be resolved when the liquid crystal device is brought back to the room temperature. So, the above-described spacer density is only a preferred range.

In the liquid crystal device of the invention, a seal material may be formed into the form of a frame, more concretely, without bulging towards the outer edge of the substrate. Also, more specifically, the seal material may be formed in to the form of a closed frame without an opening which opens to an outer edge of the substrate.

In the liquid crystal device of the invention, the spacers may be covered with a sticking layer or an adhesive layer, and fixed on the substrate through the sticking layer or the adhesive layer. In this case, it becomes possible to ensure the fixing of the spacers on the substrate further, whereby a problem, such as the spacers floating between the substrates, becomes less prone to occur.

The method of manufacturing the liquid crystal device according to the invention is a method of manufacturing the liquid crystal device having a pair of substrates, spacers located between the substrates, and a liquid crystal layer held between the substrates. The method includes: forming a closed-frame-shaped seal material on one of the pair of substrates in a region in a plane of the substrate; disposing the spacers on the one substrate; dropping a liquid crystal onto the one substrate; and gluing the paired substrates together. A dispersed density of the spacers in an region inside the seal material ranges from 100 to 300/mm², and an average particle size D of the spacers ranges from 0.96 d to 1.02 d, where a liquid crystal layer thickness in the region in which the spacers are disposed is represented by d.

This method enables the manufacture of the above-described liquid crystal device of the invention. Specifically, in the invention, substrates are glued together after a liquid crystal has been dropped onto the substrate, which makes possible to omit the more troublesome steps of injecting a liquid crystal and sealing the liquid crystal after having glued the substrates together. Further, since the substrates are glued together after a liquid crystal and spacers have been disposed on one of the substrates, the density of spacers can be reduced as described above. Concretely, the spacers have a spacer density ranging from 100 to 300/mm², and an average particle size D between 0.96 d and 1.02 d. Therefore, it becomes possible to provide a liquid crystal device, which exhibits a small range of variation in spacing between substrates and is less prone to producing a vacuum region in storage at low temperatures. Also, in this case, in order to address or resolve a problem such that the unevenness of spacing between substrates arises at high temperatures, it is preferable to set the density of spacers to 150 to 300/mm².

In the invention, the gluing of the substrates is carried out in vacuum, and thereafter the releasing of the vacuum into the atmosphere and curing the seal material may be included.

The electronic equipment of the invention includes the liquid crystal device as described above, for example, as a display device. Thus incorporating a liquid crystal device according to the invention makes it possible to provide a configuration of electronic equipment with a lower occurrence ratio of defects and higher reliability.

### BRIEF DESCRIPTION OF THE DRAWINGS

FIG. 1 is a plan view of a liquid crystal display device of an exemplary embodiment of the invention with constituent elements, which is viewed from the side of the opposed substrate;

FIG. 2 is a cross-sectional view taken along plane H-H′ in FIG. 1;

FIG. 3 is a schematic of an equivalent circuit for various elements, interconnections, etc. in a plurality of pixels formed in the form of a matrix in an image display area of the liquid crystal display device;

FIG. 4 is a partial enlarged sectional view of the liquid crystal display device;

FIG. 5 is a perspective view showing an exemplary electronic equipment in which an electro-optic device according to the invention is used;

FIG. 6 is a perspective view showing another exemplary electronic equipment; and

FIG. 7 is a perspective view showing another exemplary electronic equipment.

### DETAILED DESCRIPTION OF PREFERRED EMBODIMENTS

Exemplary embodiments of the invention are described below in reference to the drawings.

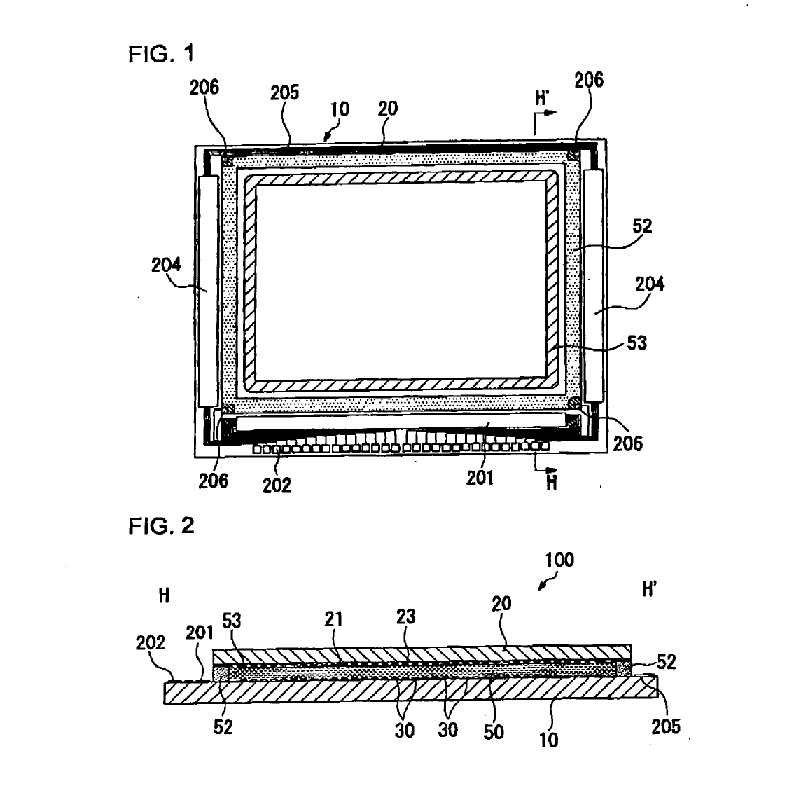

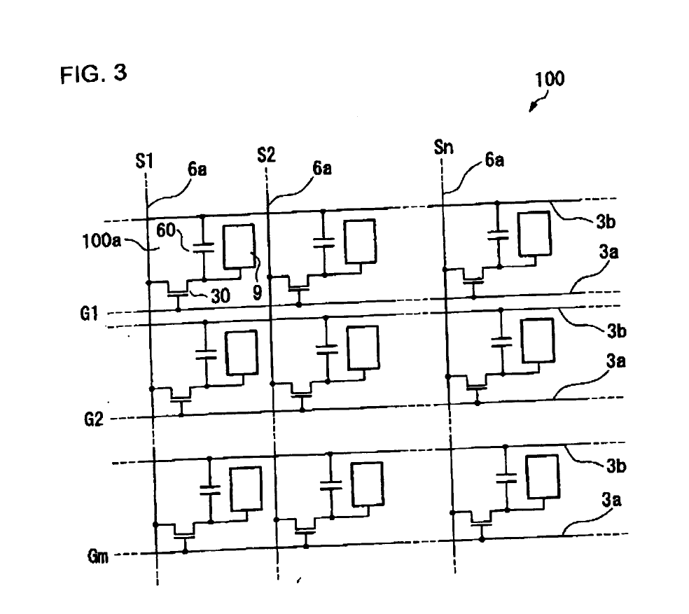

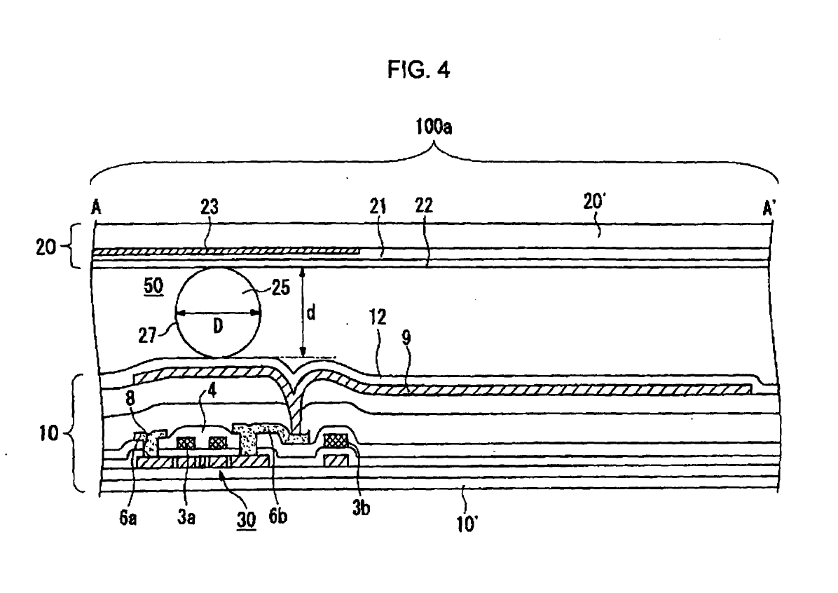

FIG. 1 is a plan view of a liquid crystal display device as an exemplary embodiment of a liquid crystal device of the invention, which is illustrated together with constituent elements and viewed from the side of an opposed substrate. FIG. 2 is a cross-sectional view taken along plane H-H′ in FIG. 1. FIG. 3 is a schematic of an equivalent circuit showing individual elements, interconnections, etc., in a plurality of pixels formed in the form of a matrix in an image display area of the liquid crystal display device. FIG. 4 is a partial enlarged sectional view of the liquid crystal display device. Layers and members differ in reduction scale individually in the drawings used for the following descriptions in order to make them recognizable sizes in the drawings.

In FIGS. 1 and 2, the liquid crystal display device 100 of the exemplary embodiment has a TFT array substrate 10 and an opposed substrate 20 glued together through a seal material 52, and a liquid crystal 50 sealed in a region defined by the seal material 52 and held there. The seal material 52 is formed into a closed frame in a region in a substrate-plane. Also, the seal material 52 is arranged not to have a so-called liquid crystal injection port, and therefore it has no trace of having been sealed up with a sealant. In this liquid crystal display device 100, a liquid crystal is dropped onto one of the substrates prior to gluing of the substrates together when manufacturing the device, followed by gluing the substrate together and then curing the seal material.

After that, a peripheral parting 53 of a light-blocking material is formed in an area inside the region where the seal material 52 is formed. In an area outside the seal material 52, a data-line driving circuit 201 and mounting terminals 202 are formed along a side of the TFT array substrate 10 and along two sides adjacent to the side are formed scanning-line driving circuits 204. Along the remaining side of the TFT array substrate 10, a plurality of interconnections 205 to connect between the scanning-line driving circuits 204 provided on the both sides of the image display area are provided. In addition, an inter-substrate conducting material 206 to secure electrical continuity between the TFT array substrate 10 and the opposed substrate 20 is disposed in at least one of corner portions of the opposed substrate 20.

Instead of forming the data-line driving circuit 201 and scanning-line driving circuits 204 on the TFT array substrate 10, a tape automated bonding (TAB) substrate with a driving LSI mounted thereon and a group of terminals formed in the peripheral portions of the TFT array substrate 10 may be connected through an anisotropic conductive film electrically and mechanically, for example. In the liquid crystal display device 100, while the phase-shift plate, polarizing plate, etc., are located so as to be directed to given directions depending on the type of liquid crystal 50 to be used, i.e., an operational mode, such as Twisted Nematic (TN) mode and Super Twisted Nematic (STN) mode, and a distinction between normally-white and normally-black modes, their illustrations are herein omitted.

Further, in the case where the liquid crystal display device 100 is arranged for the use of color display, for example, Red (R), Green (G), and Blue (B) color filters are formed, together with the resin layer which flattens a surface of the color filters, in a region of the opposed substrate 20 opposed to each pixel electrode of the TFT array substrate 10, which is described below.

In the image display area of a liquid crystal display device 100 having this configuration, a plurality of pixels 100a are arranged in the form of a matrix, as shown in FIG. 3. The pixels 100a each has a TFT 30 to switch the pixel formed therein, in which the source of the TFT 30 is electrically connected to a data line 6a for supplying pixel signals S1, S2, . . . , Sn. The pixel signals S1, S2, . . . , Sn to be written to the data lines 6a may be supplied in this order and in the sequence of the data lines. Further, of the data lines 6a, adjacent ones may be grouped to supply the pixel signals for each of the groups. The gate of the TFT 30 is electrically connected to a scanning line 3a. The pixels are also so arranged that scanning signals G1, G2, . . . , Gm are applied to the scanning lines 3a in a pulse form at a given timing in this order and in the sequence of the scanning lines.

The pixel electrode 9 is electrically connected to the drain of the TFT 30. Turning on the TFT 30, which is a switching element, only for a certain period of time can cause a pixel signal S1, S2, . . . , Sn supplied through the data line 6a to be written to the corresponding pixel at a given timing. The pixel signals S1, S2, . . . , Sn at a given level, which have been thus written to the liquid crystal through the pixel electrodes 9, are held between the pixel electrodes and an opposed electrode 21 of the opposed substrate 20 shown in FIG. 2 for a certain period of time. In order to reduce or avoid the leakage of the held pixel signals S1, S2, . . . , Sn, storage capacitances 60 are added in parallel with liquid crystal capacitances formed between the pixel electrodes 9 and the opposed electrode. For example, a voltage of the pixel electrode 9 is held by the storage capacitance 60 for a time three-orders longer than the time during which a source voltage is applied. This enhances the property of holding a charge, and therefore a liquid crystal display device 100 with a high contrast ratio can be implemented.

FIG. 4 is a partial enlarged sectional view of the liquid crystal display device 100. On the TFT array substrate 10 arranged to have a glass substrate 10′ as a main body, pixel electrodes 9 configured as transparent electrodes almost exclusively of indium tin oxide (ITO) are formed in the form of a matrix (See FIG. 3). Each of the pixel electrodes 9 is electrically connected with a TFT 30 for use of switching the pixel (See FIG. 3). Data lines 6a, scanning lines 3a, capacity lines 3b are formed along lengthwise and sidewise boundaries of regions where the pixel electrodes 9 are formed. The TFT 30 is connected to the data line 6a and the scanning line 3a. In other words, the data line 6a is electrically connected with the high-density source region la of the TFT 30 through a contact hole 8, and the pixel electrode 9 is electrically connected with the high-density drain region of the TFT 30 through the contact hole 15 and the drain electrode 6b. For a surface layer of the pixel electrode 9, an alignment layer 12 is formed by performing rubbing treatment on a film made almost exclusively of a polyimide.

On the other hand, as for the opposed substrate 20, a light-blocking layer 23 referred to as a black matrix or black stripe is formed in regions on the glass substrate 20′ on the side of the opposed substrate, which are opposed to the lengthwise and sidewise boundary regions of the pixel electrodes 9 on the TFT array substrate 10. On the side of the top surface of the light-blocking layer, an opposed electrode 21 composed of an ITO film is formed. Further, an alignment layer 22 composed of a polyimide film is formed on the side of the top surface of the opposed electrode 21. A liquid crystal 50 is sealed in by a seal material 52 with spacers 25 interposed between the TFT array substrate 10 and the opposed substrate 20 (See FIG. 1).

Now, when a liquid crystal layer thickness in a region where spacers 25 are disposed is represented by d, an average particle size D of the spacers 25 is set in the range of 0.96 d to 1.02 d. Further, the density of spacers 25 is set in the range of 100 to 300/mm². On the surface of the spacers 25, there is formed a sticking layer (adhesive layer) 27 made of a resin with a high adhesiveness. The sticking layer 27 adheres to the surface of the TFT array substrate 10, whereby the spacer 25 is fixed on the TFT array substrate 10.

In the liquid crystal display device 100 of the exemplary embodiment, the seal material 52 is formed into a closed frame in a region in a substrate-plane (see FIG. 1). Therefore, it is possible to drop a liquid crystal onto one of the substrates and then glue the substrate to the other one prior to the step of gluing the substrates together when manufacturing the liquid crystal display device. In this case, since there is no need to undergo the injecting of a liquid crystal after having glued the substrates together, the manufacturing process becomes simple and easy. Further, in the liquid crystal device with this seal material, spacers having an average particle size D from 0.96 d to 1.02 d are used and a spacer density in the seal material is set in the range of 100 to 300/mm². As a result, the spacing between substrates becomes more uniform and therefore the variation in the spacing between substrates, for example, can be reduced to the order of ±1%. Also, a problem such as the generation of a vacuum region (bubble) in storage at low temperatures can be addressed or resolved. It is desirable to adopt a value from 150 to 300/mm² as a spacer density. In this case, it is possible to address or resolve a problem such that the spacing between substrates becomes uneven due to the difference in thermal expansion between spacers and a liquid crystal at a high temperature.

A method of manufacturing the liquid crystal display device 100 is described below. More specifically, the forming of a seal material to the dropping of a liquid crystal and gluing substrates together in the manufacturing process are explained below.

First, TFTs 30 are formed on a glass substrate 10′, as shown in FIG. 4. Further, pixel electrodes 9, an alignment layer 12, etc., are formed thereon to prepare a TFT array substrate 10. In contrast, on a glass substrate 20′ are formed a light-blocking layer 23, an opposed electrode 21, an alignment layer 22, etc., to prepare an opposed substrate 20. After that, an adhesive is put on at least one of the TFT array substrate 10 and the opposed substrate 20 (e.g. TFT array substrate 10) so as to take the form of a closed frame, namely a so-called form with no liquid crystal injection port, in a substrate-plane. In this case, the adhesive is shaped into a given form by a patterning method using a dispenser.

Next, spacers 25 are dispersed inside the closed-frame-shaped adhesive, followed by dropping a liquid crystal 50 onto a region surrounded by the adhesive. In this case, a dispersed density of spacers 25 is set in the range of 100 to 300/mm² (preferably, 150 to 300/mm²) in a region inside the adhesive and an average particle size D of spacers 25 is 0.96 d to 1.02 d, where “d” indicates a thickness of a liquid crystal layer.

Then, the TFT array substrate 10 and the opposed substrate 20 are glued together under vacuum. After uniting the substrates 10 and 20, the vacuum is released into the atmosphere, and the adhesive is cured, whereby a liquid crystal panel for the liquid crystal display device 100 as shown in FIG. 1 can be manufactured. In this case, the adhesive includes a photo-hardening component (photo-hardening group), which is cured by irradiation with light, and a thermosetting component (thermosetting group), which is cured by heating. After the adhesive is temporarily cured by irradiation with light, the permanent curing is performed by heating. In light irradiation, an amount of light irradiation is 1000 to 6000 mJ/cm² (e.g. 5000 mJ/cm²), whereas in heating a heating temperature is 60 to 160° C. (e.g. 100° C.), and a heating time is 20 to 300 minutes (e.g. 120 minutes).

As stated above, the liquid crystal display device 100 of the exemplary embodiment can be manufactured by a method such that substrates are glued together after having dropped a liquid crystal onto at least one of the substrates. In this case, a pressure produced in gluing the substrates together is to be applied to not only the spacers 25 but also the liquid crystal 50 and therefore the number (dispersed density) of spacers 25 can be relatively decreased in comparison to a manufacturing method in the case where a conventional liquid crystal injection port is provided, i.e., a method such that a liquid crystal is injected after having glued the substrates together. Accordingly, it becomes possible to make a spacer density comparatively smaller, from 100 to 300/mm², as described above. Further, under the condition of this spacer density, an average spacer particle size D is set in the range of 0.96 d to 1.02 d, where d is a thickness of the liquid crystal layer. This can make the spacing between substrates more uniform and therefore it becomes possible to provide a liquid crystal device, which is less prone to producing a bubble, etc., in a liquid crystal even in the case where the liquid crystal device is placed under the condition of a low temperature. Further, in the case where a spacer density is set in the range of 150 to 300/mm², it becomes possible to provide a liquid crystal device which is less prone to producing any troubles, such as deterioration in contrast even when the device is placed under the condition of a high temperature. Consequently, it has become possible to provide a liquid crystal display device with outstanding display properties and high reliability where the occurrence of defects is reduced.

[Exemplary Electronic Equipment]

Concrete examples of electronic equipment having the liquid crystal display device shown in the above exemplary embodiment are described.

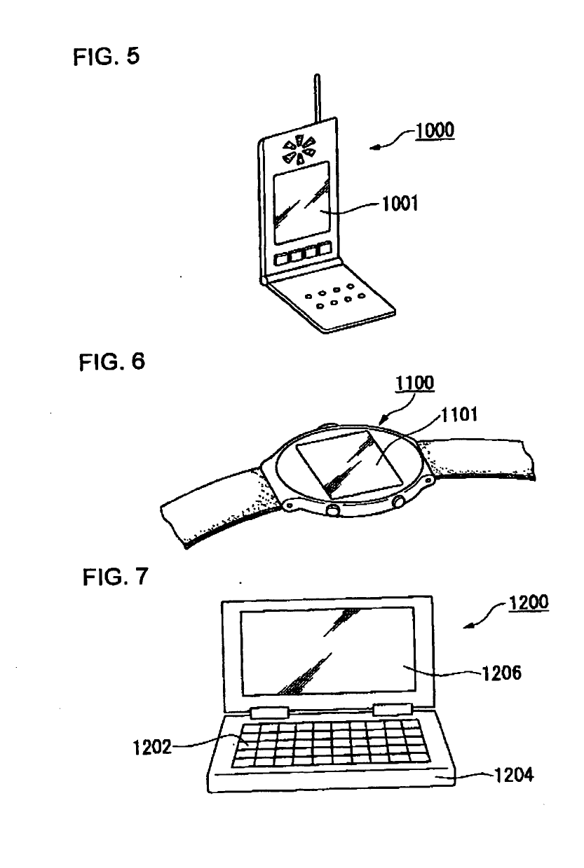

FIG. 5 is a perspective view showing an example of a cellular phone. In FIG. 5, reference numeral 1000 indicates a main body of a cellular phone, and reference numeral 1001 indicates a liquid crystal display unit having a liquid crystal device according to the above exemplary embodiment.

FIG. 6 is a perspective view showing an example of a watch-type electronic equipment. In FIG. 6, the reference numeral 1100 indicates the main body of the watch, and reference numeral 1101 indicates a liquid crystal display unit having a liquid crystal device according to the above exemplary embodiment.

FIG. 7 is a perspective view showing an example of portable information processing equipment, such as a word processor and a personal computer, for example. In FIG. 7, reference numeral 1200 indicates a configuration of information processing equipment, reference numeral 1202 indicates an input unit such as a keyboard, the numeral 1204 indicates a main body for information processing, and reference numeral 1206 indicates a liquid crystal display unit having a liquid crystal device according to the above exemplary embodiment.

Thus, the examples of electronic equipment shown in FIGS. 5 to 7 each have any one of liquid crystal devices according to the above exemplary embodiment, and therefore they have outstanding display quality and high reliability.

### [EXAMPLE]

In order to confirm the properties of a liquid crystal device according to the invention, the invention has been embodied as follows.

### (Example 1)

The liquid crystal display device of Example 1 is a liquid crystal display device in the case wherein resin spacers 25 having an average particle size D=3 μm were used. More specifically, after patterning the above-described adhesive into the form of a closed frame on a glass substrate (downside substrate) measuring 370 mm in width and 470 mm in length with a dispenser, the spacers were dispersed at a density of 80 to 350/mm² as shown in Table 1, followed by heating the substrate at 100° C. for 10 minutes to stick the spacers to the surface of the substrate and further dropping a liquid crystal (of a super twisted nematic type) onto the substrate with a dispenser.

After that, the substrate, onto which a liquid crystal was dropped, was glued to the other substrate (upside substrate) to release the vacuum into the atmosphere, followed by performing ultraviolet (UV) exposure to the surface of the substrate using a high-pressure mercury vapor lamp with an output power of 100 mW/cm² (365 nm) as a UV irradiator. Then, the substrate was heated in an oven to cure the adhesive completely. After this curing treatment, panels were cut from the substrate, whereby liquid crystal display devices having a configuration as shown in FIG. 1 were obtained. Now, as for such display device, a plurality of liquid crystal display devices, which differ from device to device in liquid crystal layer thickness d as shown in Table 1, were prepared by changing the dropping amount of the liquid crystal.

For the liquid crystal display devices thus obtained, the cell gap defect occurrence ratio (Table 1), the vacuum region occurrence ratio at a low temperature (Table 2), and the cell gap defect occurrence ratio at a high temperature (Table 3) were measured.

As the cell gap defect occurrence ratio, the number of defectives of 400 manufactured panels was measured in percentages as an occurrence ratio of the defect. In this measurement, maximum and minimum values of cell gaps in the plane of the panel were measured, the panel whose maximum value exceeds 101% of a designed cell gap of the panel or whose minimum value is below 99% of the designed cell gap was judged to be a defective. The results of the measurement are shown in Table 1. The designed cell gap herein means a theoretical value of a cell gap calculated on the basis of a dropping amount of liquid crystal.

For the vacuum region occurrence ratio at a low temperature, after 200 manufactured panels were left at −30° C. for 10 hours, a percentage of panels in which vacuum regions arose due to the contraction of liquid crystal with respect to the 200 panels was measured. The results of the measurement are shown in Table 2.

The cell gap defect occurrence ratio at a high temperature is a cell gap defect occurrence ratio at 70° C. in percentages. The results thereof are shown in Table 3.

Further, preferred conditions for the manufacture of the devices have been examined on the basis of the cell gap defect occurrence ratio, the vacuum region occurrence ratio at a low temperature, and the cell gap defect occurrence ratio at a high temperature. The results are shown in Table 4. In Table 4, a blank represents that any of a cell gap defect and a vacuum region at a low temperature arose; a circle indicates that neither cell gap defect nor vacuum region at a low temperature did not arise but a cell gap defect at a high temperature occurred; and a double circle indicates that any of the cell gap defect, vacuum region at a low temperature, and cell gap defect at a high temperature did not arise.

TABLE 1

| | d (μm) (D/d) | | | | | | | |
|---|---|---|---|---|---|---|---|---|
| | 2.83 | 2.88 | 2.94 | 3.00 | 3.06 | 3.13 | 3.19 | 3.26 |
| DENSITY | (1.06) | (1.04) | (1.02) | (1.00) | (0.98) | (0.96) | (0.94) | (0.92) |
| 80 | 0 | 0 | 0 | 1 | 3 | 6 | 12 | 23 |
| 100 | 0 | 0 | 0 | 0 | 0 | 0 | 8 | 17 |
| 150 | 0 | 0 | 0 | 0 | 0 | 0 | 4 | 9 |
| 200 | 0 | 0 | 0 | 0 | 0 | 0 | 2 | 5 |
| 300 | 0 | 0 | 0 | 0 | 0 | 0 | 2 | 3 |
| 350 | 0 | 0 | 0 | 0 | 0 | 0 | 1 | 2 |

TABLE 2

| | d (μm) (D/d) | | | | | | | |
|---|---|---|---|---|---|---|---|---|
| | 2.83 | 2.88 | 2.94 | 3.00 | 3.06 | 3.13 | 3.19 | 3.26 |
| DENSITY | (1.06) | (1.04) | (1.02) | (1.00) | (0.98) | (0.96) | (0.94) | (0.92) |
| 80 | 2 | 0 | 0 | 0 | 0 | 0 | 0 | 0 |
| 100 | 6 | 0 | 0 | 0 | 0 | 0 | 0 | 0 |
| 150 | 8 | 0 | 0 | 0 | 0 | 0 | 0 | 0 |
| 200 | 12 | 4 | 0 | 0 | 0 | 0 | 0 | 0 |
| 300 | 21 | 14 | 0 | 0 | 0 | 0 | 0 | 0 |
| 350 | 47 | 27 | 14 | 4 | 1 | 0 | 0 | 0 |

TABLE 3

| | d (μm) (D/d) | | | | | | | |
|---|---|---|---|---|---|---|---|---|
| | 2.83 | 2.88 | 2.94 | 3.00 | 3.06 | 3.13 | 3.19 | 3.26 |
| DENSITY | (1.06) | (1.04) | (1.02) | (1.00) | (0.98) | (0.96) | (0.94) | (0.92) |
| 80 | 4 | 5 | 8 | 11 | 17 | 32 | 43 | 50 |
| 100 | 0 | 0 | 0 | 2 | 5 | 13 | 20 | 33 |
| 150 | 0 | 0 | 0 | 0 | 0 | 0 | 1 | 15 |
| 200 | 0 | 0 | 0 | 0 | 0 | 0 | 0 | 4 |
| 300 | 0 | 0 | 0 | 0 | 0 | 0 | 0 | 0 |
| 350 | 0 | 0 | 0 | 0 | 0 | 0 | 0 | 0 |

TABLE 4

| | d (μm) (D/d) | | | | | | | |
|---|---|---|---|---|---|---|---|---|
| | 2.83 | 2.88 | 2.94 | 3.00 | 3.06 | 3.13 | 3.19 | 3.26 |
| DENSITY | (1.06) | (1.04) | (1.02) | (1.00) | (0.98) | (0.96) | (0.94) | (0.92) |
| 80 | | ◯ | ◯ | | | | | |
| 100 | | ⊚ | ⊚ | ◯ | ◯ | ◯ | | |
| 150 | | ⊚ | ⊚ | ⊚ | ⊚ | ⊚ | | |
| 200 | | | ⊚ | ⊚ | ⊚ | ⊚ | | |
| 300 | | | ⊚ | ⊚ | ⊚ | ⊚ | | |
| 350 | | | | | | ⊚ | | |

Table 1 shows that the occurrence ratio of defects for cell gaps is higher in the case where the average spacer particle size D is below 0.96 d. Further, as for the spacer density, the smaller the density is, the higher the occurrence ratio of cell gap defects is, especially in the case where the density is below 100/mm².

In contrast, Table 2 shows that the vacuum region occurrence ratio becomes higher in the case where the average spacer particle size D exceeds d, whereas the vacuum region occurrence ratio can be reduced by setting the spacer density less than 300/mm². However, it is further recognized that a vacuum region arise at a high probability independently of the average spacer particle size D when the spacer density is set at 350/mm². As it is shown in Table 3, that the occurrence ratio of defects at a high temperature is higher in the case where the spacer density is less than 150/mm².

From the results described above, as shown in Table 4, in the case of the liquid crystal device with a closed frame-shaped seal material, setting the spacer density in the range of 100 to 300/mm² and the average spacer particle size D in the range of 0.96 d to 1.02 d can reduce the tendency to produce display defects and can provide a liquid crystal device with high reliability. Further, it is also clear that setting the spacer density in the range of 150 to 300/mm² can minimize the occurrence of defects at a high temperature. The deviations of patterns after separating panels were all less than or equal to 1 μm in this example.

### (Example 2)

The average particle size of spacers to be used was set to 6 μm to manufacture the same liquid crystal devices as those for Example 1. For the liquid crystal devices, the cell gap defect occurrence ratio (Table 5), the vacuum region occurrence ratio at a low temperature (Table 6), and the cell gap defect occurrence ratio at a high temperature (Table 7) were measured. Further, preferred conditions for the manufacture of the devices have been examined on the basis of the cell gap defect occurrence ratio, the vacuum region occurrence ratio at a low temperature, and the cell gap defect occurrence ratio at a high temperature as in the case of Example 1. The results are presented in Table 8.

TABLE 5

| | d (μm) (D/d) | | | | | | | |
|---|---|---|---|---|---|---|---|---|
| | 5.66 | 5.77 | 5.88 | 6.00 | 6.12 | 6.25 | 6.38 | 6.52 |
| DENSITY | (1.06) | (1.04) | (1.02) | (1.00) | (0.98) | (0.96) | (0.94) | (0.92) |
| 80 | 0 | 0 | 0 | 0 | 1 | 2 | 6 | 14 |
| 100 | 0 | 0 | 0 | 0 | 0 | 0 | 4 | 8 |
| 150 | 0 | 0 | 0 | 0 | 0 | 0 | 2 | 6 |
| 200 | 0 | 0 | 0 | 0 | 0 | 0 | 1 | 4 |
| 300 | 0 | 0 | 0 | 0 | 0 | 0 | 0 | 3 |
| 350 | 0 | 0 | 0 | 0 | 0 | 0 | 0 | 1 |

TABLE 6

| | d (μm) (D/d) | | | | | | | |
|---|---|---|---|---|---|---|---|---|
| | 5.66 | 5.77 | 5.88 | 6.00 | 6.12 | 6.25 | 6.38 | 6.52 |
| DENSITY | (1.06) | (1.04) | (1.02) | (1.00) | (0.98) | (0.96) | (0.94) | (0.92) |
| 80 | 2 | 1 | 0 | 0 | 0 | 0 | 0 | 0 |
| 100 | 3 | 1 | 0 | 0 | 0 | 0 | 0 | 0 |
| 150 | 5 | 2 | 0 | 0 | 0 | 0 | 0 | 0 |
| 200 | 8 | 3 | 0 | 0 | 0 | 0 | 0 | 0 |
| 300 | 17 | 10 | 0 | 0 | 0 | 0 | 0 | 0 |
| 350 | 37 | 14 | 5 | 2 | 2 | 1 | 0 | 0 |

TABLE 7

| | d (μm) (D/d) | | | | | | | |
|---|---|---|---|---|---|---|---|---|
| | 5.66 | 5.77 | 5.88 | 6.00 | 6.12 | 6.25 | 6.38 | 6.52 |
| DENSITY | (1.06) | (1.04) | (1.02) | (1.00) | (0.98) | (0.96) | (0.94) | (0.92) |
| 80 | 0 | 0 | 0 | 2 | 5 | 14 | 29 | 32 |
| 100 | 0 | 0 | 0 | 0 | 3 | 9 | 15 | 19 |
| 150 | 0 | 0 | 0 | 0 | 0 | 0 | 0 | 12 |
| 300 | 0 | 0 | 0 | 0 | 0 | 0 | 0 | 0 |
| 350 | 0 | 0 | 0 | 0 | 0 | 0 | 0 | 0 |

TABLE 8

| | d (μm) (D/d) | | | | | | | |
|---|---|---|---|---|---|---|---|---|
| | 5.66 | 5.77 | 5.88 | 6.00 | 6.12 | 6.25 | 6.38 | 6.52 |
| DENSITY | (1.06) | (1.04) | (1.02) | (1.00) | (0.98) | (0.96) | (0.94) | (0.92) |
| 80 | | | ⊚ | ◯ | | | | |
| 100 | | | ⊚ | ⊚ | ◯ | ◯ | | |
| 150 | | | ⊚ | ⊚ | ⊚ | ⊚ | | |
| 200 | | | ⊚ | ⊚ | ⊚ | ⊚ | | |
| 300 | | | ⊚ | ⊚ | ⊚ | ⊚ | ◯ | |
| 350 | | | | | | | ◯ | |

From the results, it can be seen that setting the average particle size D not according to a specific value for the average spacer particle size D but in connection with a liquid crystal layer thickness d and setting the spacer density so as to satisfy the preferred conditions can avoid or minimize the occurrence of cell gap defects, the occurrence of vacuum regions at a low temperature, and the occurrence of cell gap defects at a high temperature. Also in the case of having used spacers to an active-element-type liquid crystal device with thin film diodes (TFDs) or thin film transistors (TFTs) according to the invention, the same effects as those for the liquid crystal device illustrated herein were obtained.

[Advantages of the Invention]

As described above, according to the liquid crystal device of the invention, the seal material is formed into the form of a closed frame (a closed frame shape) in a region in a plane of the substrate. Therefore, it is possible to drop a liquid crystal onto one of the substrates and then glue the substrate to the other one prior to the step of gluing the substrates together when manufacturing the liquid crystal device. In this case, since there is no need to undergo the step of injecting a liquid crystal after having glued the substrates together, the manufacturing process becomes simple and easy.

Further, in the liquid crystal device with this closed-frame-shaped seal material, spacers having an average particle size D from 0.96 d to 1.02 d (d: thickness of a liquid crystal layer to be spacers are arranged) are used, and a spacer density in the seal material is set in the range of 100 to 300/mm². As a result, the spacing between substrates becomes more uniform and therefore the variation of the spacing between substrates, for example, can be reduced to the order of ±1%. Also, a problem, such as the generation of a vacuum region (bubble) in storage at low temperatures can be addressed or resolved. Further, in the case where the density of spacers is set in the range of 150 to 300/mm², it becomes possible to reduce, avoid or minimize the produce of variations of spacing between substrates at high temperatures.

What is claimed is:

1. A liquid crystal device, comprising:
a pair of substrates;
spacers located between the substrates; and
a liquid crystal layer held between the substrates, the liquid crystal layer and spacers being located in a region surrounded by a frame-shaped seal material formed in a plane of the substrate, a density of the spacers in the region ranging from 100 to 300/mm², and an average particle size D of the spacers ranging from 0.96 d to 1.02 d, where a liquid crystal layer thickness in the region in which the spacers are disposed is represented by d.

2. A liquid crystal device, comprising:
a pair of substrates;
spacers located between the substrates; and
a liquid crystal layer held between the substrates, the liquid crystal layer and spacers being located in a region surrounded by a frame-shaped seal material formed in a plane of the substrate, a density of the spacers in the region ranging from 150 to 300/mm², and an average particle size D of the spacers ranging from 0.96 d to 1.02 d, where a liquid crystal layer thickness in the region in which the spacers are disposed is represented by d.

3. The liquid crystal device according to claim 1, the seal material being formed into the form of a closed frame without an opening which opens to an outer edge of the substrate.

4. The liquid crystal device according to claim 1, the spacers being covered with a sticking layer or an adhesive layer, and fixed on the substrate through the sticking layer or the adhesive layer.

5. A method of manufacturing a liquid crystal device having a pair of substrates, spacers located between the substrates, and a liquid crystal layer held between the substrates, the method comprising:
forming a closed-frame-shaped seal material on one of the pair of substrates in a region in a plane of the substrate;
disposing the spacers on the one substrate;
dropping a liquid crystal onto the one substrate; and
gluing the paired substrates together, a dispersed density of the spacers in a region inside the seal material ranging from 100 to 300/mm², and an average particle size D of the spacers ranges from 0.96 d to 1.02 d, where a liquid crystal layer thickness in the region in which the spacers are disposed being represented by d.

6. A method of manufacturing the liquid crystal device having a pair of substrates, spacers located between the substrates, and a liquid crystal layer held between the substrates, the method comprising:
forming a closed-frame-shaped seal material on one of the pair of substrates in a region in a plane of the substrate;
disposing the spacers on the one substrate;
dropping a liquid crystal onto the one substrate; and
gluing the paired substrates together, a dispersed density of the spacers in a region inside the seal material ranging from 150 to 300/mm², and an average particle size D of the spacers ranges from 0.96 d to 1.02 d, where a liquid crystal layer thickness in the region in which the spacers are disposed being represented by d.

7. The method of manufacturing the liquid crystal device according to claim 5, the gluing the substrates being carried out under vacuum, the method further including:
releasing the vacuum into the atmosphere, and curing the seal material after having carried out the gluing of the substrates.

8. The method of manufacturing the liquid crystal device according to claim 5, further including covering the spacers with a sticking layer or an adhesive layer.

9. A configuration of electronic equipment, comprising:
the liquid crystal device according to claim 1.
